(19) United States
(12) Patent Application Publication
(10) Pub. No.: US 2025/0249420 A1
(43) Pub. Date: Aug. 7, 2025

(54) PROCESS FOR COATING A GRANULAR MATERIAL, COATED GRANULAR MATERIAL AND KIT

(71) Applicant: ASK CHEMICALS GMBH, Hilden (DE)

(72) Inventors: Jean-Pascal SCHULTE, Ratingen (DE); Martin KEMNA, Wuppertal (DE); Jan KLESING, Essen (DE); Ralf KRUME, Wuppertal (DE); Heinz DETERS, Düsseldorf (DE)

(21) Appl. No.: 18/702,276

(22) PCT Filed: Oct. 17, 2022
(86) PCT No.: PCT/EP2022/078813

§ 371 Date: Apr. 17, 2024

(30) Foreign Application Priority Data
Oct. 18, 2021 (DE) 10 2021 005 190.4

(51) Int. Cl. B01J 2/00; C09D 163/00

(52) U.S. Cl. CPC B01J 2/006; C09D 163/00

(57) ABSTRACT

The present invention relates to a method of coating a granular material comprising the steps of (a) providing a granular substance; (b) providing a compound (C) which has at least one ester bond and which is obtainable by reacting a hydroxyl group or epoxy group of a compound (A) with a carboxyl group or anhydride group of a compound (B); (c) providing a compound (D) having at least one epoxy group; (d) reacting compound (C) with the epoxy group of compound (D) to produce compound (E) having an ester bond; wherein the reaction of compound (C) with compound (D) takes place in the presence of the granular material and optionally a curing agent to provide a coated granular material; and wherein the compound (A) has at least one hydroxyl group or epoxy group and is selected from fatty acid ester and fatty acid; and the compound (B) is selected from: compound (B-1) having at least two carboxyl groups; and compound (B-2) having at least one cyclic anhydride group. Furthermore, the invention relates to a coated granular material obtainable by the process according to the invention and to a kit comprising compound (C) and compound (D) and optionally a curing agent.

### TECHNICAL FIELD

The present invention relates to a method for coating a granular material, and to a coated granular material obtainable according to the method of the invention. Furthermore, the invention relates to a kit for producing the coated granular material.

### STATE OF THE ART

Granular, at least partially water-soluble substances coated with a water-insoluble but water-permeable layer are generally known. These substances have gained particular importance in the field of fertilizers, since the rate of dissolution of the active ingredients can be controlled by the coating. In this way, it is possible to obtain slow-release fertilizers with an effectiveness of several months.

Various systems have been recommended as coating resins.

DE 1 242 573 A describes a process for encapsulating granules with a coating agent, which in one embodiment is a copolymer of dicyclopentadiene with drying or semi-drying oil.

DE 2 155 924 A discloses that a special resol resin can be used for coating granulated fertilizers.

WO 02/096548 discloses a coated granular material, the coating comprising the reaction product of (A) an acid-modified fatty (acid) component and (B) an epoxy component. “Acid-modified” refers to originally unsaturated compounds into which acid functionality(s) has been introduced by reaction of the unsaturated moieties with unsaturated carboxylic acids or carboxylic anhydrides. The Diels-Alder reaction is given as an example. In each example, maleic anhydride is reacted with either soybean oil, linseed oil, or linseed oil canola fatty acid.

Preferably used are fats or oils which have as high a proportion of unsaturated fatty acids as possible, since this is of course the prerequisite for a well-functioning Diels-Alder reaction.

However, it has been shown that the presence of double bonds can lead to subsequent oxidative crosslinking by means of oxygen. The resulting ether bridges are poorly biodegradable or not biodegradable at all.

WO 96/41779 describes special fertilizer granules coated with a carboxyl group-bearing ethylene copolymer in which the carboxyl groups may also be present in the form of their salts.

In EP 0 230 601 A and EP 1 451 129 A, 2-component polyurethane systems are used.

However, it has been shown that polyurethane coatings do not exhibit the necessary biodegradability.

### DESCRIPTION OF THE FIGURE

FIG. 1 shows the measurement of conductivity in the leaching tests.

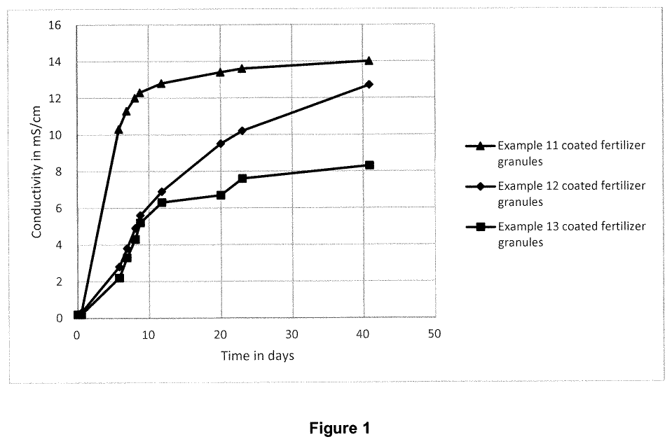

### OBJECT OF THE INVENTION

It is an object of the present invention to provide a coated granular material, wherein the coating has an improved biodegradability. The coating should further allow controlled release of the granular material to the environment. The corresponding manufacturing process should be fast and inexpensive to perform.

### DISCLOSURE OF THE INVENTION

Accordingly, the present invention relates to a method for coating a granular material comprising the steps of
(a) providing a granular material;
(b) providing a compound (C) which has at least one ester bond and which is obtainable by reacting a hydroxy group or epoxy group of a compound (A) with a carboxy group or anhydride group of a compound (B);
(c) providing a compound (D) having at least one epoxy group;
(d) reacting compound (C) with the epoxy group of compound (D) to produce a compound (E) having an ester bond;
   wherein the reaction of the compound (C) with the compound (D) takes place in the presence of the granular material and optionally a curing agent to provide a coated granular material; and
wherein
the compound (A) has at least one hydroxy group or epoxy group and is selected from fatty acid ester and fatty acid; and
the compound (B) is selected from:
   compound (B-1) having at least two carboxy groups; and
   compound (B-2) having at least one cyclic anhydride group.

Furthermore, the invention relates to a coated granular material obtainable by the method according to the invention as well as to a kit for producing the coated granular material.

The coating provided by the present invention is biodegradable. Due to its composition, it can act as a barrier on the one hand and ensure the delayed release of the granular material on the other hand. The coating may furthermore serve as both a dust barrier and a mechanical stabilizer for the granular material.

The process can be easily carried out using conventional devices, and in particular the reaction of the carboxy group of compound (C) with the epoxy group of compound (D) can be carried out at moderate temperatures and in a short time.

The problems mentioned above, such as oxidative crosslinking, can be avoided.

### DETAILED DESCRIPTION

### Step (a): Providing a Granular Material

The granular material to be coated is not critical. In principle, all granular materials could be provided with a coating using the present process. For example, the granular material may be selected from asymmetrically shaped granular materials (granules) or symmetrically shaped granular materials (pellets). Typical pellets, e.g., may have the shape of a sphere, a rod, a cylinder, or an ellipsoid. Typical granules include asymmetric aggregates of powder particles, whole crystals, crystal fragments or particles, or other fragments. The granular material may be porous or non-porous.

The grain size of the granular materials to be coated is not critical, either. For example, it can range from about 0.5 to about 10 mm (longest mean diameter), with a mean grain size in the range of about 1 to about 5 mm being preferred.

The process is of particular importance when coating water-soluble granular materials or those granular materials which have a water-soluble content or are impregnated with a water-soluble substance. Preferred granular materials to be coated are therefore selected from wholly or partially water-soluble granular materials. The solubility of the water-soluble components of the granular material in water at 20° C. is preferably at least about 10 g/liter, more preferably at least about 30 g/liter, and particularly preferably at least about 100 g/liter. Preferably, the granular materials to be coated consist entirely of water-soluble constituents.

Examples of granular materials are agrochemicals such as fertilizers, plant protection products, pesticides (including insecticides, herbicides, fungicides, bactericides, acaricides, molluscicides, nematicides, rodenticides, avicides), growth regulators, trace elements, soil conditioners, nitrification inhibitors, urease inhibitors, pheromones, repellents against animals and insects, and mixtures. Preferred granular materials include fertilizers and trace elements, especially fertilizers. Preferably, the granular material comprises the afore-mentioned agrochemicals or the granular material consists of the afore-mentioned agrochemicals. Preferred granular materials that are at least partially water-soluble are fertilizers.

Fertilizers suitable for coating are organic and mineral fertilizers and mixtures thereof. For example, single or compound fertilizers are suitable, which individually or in combination contain nutrients such as nitrogen, potassium, or phosphorus in the form of their salts or oxides. Examples are NP, NK, PK or NPK fertilizers, such as calcium ammonium nitrate, ammonium sulfate, ammonium sulfate nitrate, calcium cyanamide or urea. In addition to the main constituents mentioned, the fertilizer granules may also contain salts of trace elements, such as magnesium, iron, manganese, copper, zinc, molybdenum and/or boron in small amounts, usually in amounts of about 0.5 to about 5% by weight. Suitable organic fertilizers include guano, fish meal, bone meal or lignin.

In the present invention, very highly water-soluble or hygroscopic substances can also be used as the granular material to be coated, e.g. drying agents such as phosphorus pentoxide or calcium chloride. The coating can prevent too rapid deliquescence in a humid environment.

Step (b): Providing a Compound (C) which has at Least One Ester Bond and which is Obtainable by Reacting a Hydroxyl Group or Epoxy Group of a Compound (A) with a Carboxyl Group or Anhydride Group of a Compound (B)

Compound (C) can be provided by any process. It is preferably synthesized by reacting a hydroxyl group or epoxy group of compound (A) with a carboxyl group or anhydride group of compound (B).

Step (b-1): Providing a Compound (A) Having at Least One Hydroxyl Group or Epoxy Group, Wherein the Compound (A) is Selected from Fatty Acid Ester and Fatty Acid

Compound (A) having at least one hydroxyl group or epoxy group is not particularly limited and is selected from fatty acids and fatty acid esters. Preferably, compound (A) is selected from fatty acid esters. Mixtures of compounds (A) are also possible.

### Fatty Acids and Fatty Acid Esters

In the present invention, a fatty acid is defined as a monocarboxylic acid having a saturated or unsaturated hydrocarbon chain. For example, the hydrocarbon chain may have from about 3 to about 24 carbon atoms, preferably from about 10 to about 22 carbon atoms, more preferably from about 12 to about 20 carbon atoms, even more preferably about 17 carbon atoms (when determining the number of carbon atoms, the carbon atom of the carboxylic acid group is not counted). The number of double bonds may range from 0 to about 6, preferably 0 to about 3, more preferably 0 to about 2, even more preferably 0 or about 1, further preferably about 1. Since the double bonds have an influence on the subsequent oxidative crosslinking and thus worsen the biodegradability, a low number or absence of double bonds is advantageous. If double bonds are present, it is preferred that they are not conjugated.

The at least one hydroxyl group or epoxy group is typically attached to the fatty acid moiety. The fatty acid has at least about 1, preferably about 1 to about 3 hydroxyl groups or epoxy groups, more preferably about 1 or about 2 hydroxyl groups or epoxy groups, even more preferably about 1 hydroxyl group or epoxy group.

Certain fatty acids such as ricinoleic acid naturally have a hydroxyl group. The hydroxyl group or epoxy group may alternatively be introduced synthetically. Various processes are known in the art. One possible process is disclosed in EP 0 554 590 A2.

Examples of fatty acids include ricinoleic acid and 12-hydroxystearic acid. The use of artificially produced dimer fatty acids is also conceivable. Ricinoleic acid ((9Z,12R)-12-hydroxy-9-octadecenoic acid) is particularly preferred because it naturally has a hydroxyl group and is readily available.

The fatty acid ester in the present invention may be a fatty acid ester of a polyhydric alcohol and a fatty acid, wherein the fatty acid may be as defined above. The fatty acid ester may be of natural or synthetic origin, with natural fatty acid esters being more suitable in terms of environmental compatibility.

The polyhydric alcohol is not limited and may be selected, for example, from saturated, linear, branched or cyclic (preferably linear), aliphatic alcohols having from about 2 to about 20, preferably from about 2 to about 16, more preferably from about 2 to about 12 carbon atoms. The polyhydric alcohol may optionally contain about 1 or about 2 ether oxygen atoms, preferably no ether oxygen atoms are present. Preferred polyhydric alcohols have at least about 2, preferably about 2 to about 10, more preferably about 2 to about 8, even more preferably about 2 to about 6 hydroxyl groups per molecule. Specific examples include glycerol, diglycerol, triglycerol, ethylene glycol, diethylene glycol, propylene glycol, propanediol, butanediol, pentanediol, hexanediol, dipropylene glycol, neopentyl glycol, trimethylolethane, trimethylolpropane, pentaerythritol, dipentaerythritol, sugar alcohols (e.g. mannitol, isomalt, lactitol, sorbitol, isosorbitol, xylitol, threitol, erythritol and arabitol), dimethylolcyclohexane and cyclohexanediol. Glycerol is most preferred because triglycerides are widespread and readily available. In addition, natural triglycerides are particularly desirable as compound (A) in terms of biodegradability. It is also possible to use mixtures of polyhydric alcohols.

In the fatty acid ester, at least 1 hydroxyl group, preferably at least 2 hydroxyl groups, more preferably all hydroxyl groups of the polyhydric alcohol are attached to the fatty acid(s).

A preferred fatty acid ester is the reaction product of ricinoleic acid and glycerol:

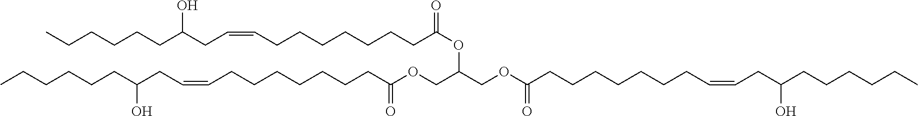 [SMILES: CCCCCCC(O)C/C=C\CCCCCCCC(=O)OCC(COC(=O)CCCCCCC/C=C\CC(O)CCCCCC)OC(=O)CCCCCCC/C=C\CC(O)CCCCCC]

In the above scheme, all three hydroxyl groups of glycerol are esterified. However, it goes without saying that it is sufficient for the purposes of the invention if at least one of the hydroxyl groups is esterified.

The fatty acid ester may be of natural origin or produced synthetically. Castor oil is particularly preferred as a natural fatty acid ester. The synthesis of fatty acid ester from polyhydric alcohol and fatty acid can be carried out by conventionally known methods.

In particular, the fatty acid may have the formula (a-3) or (a-4)

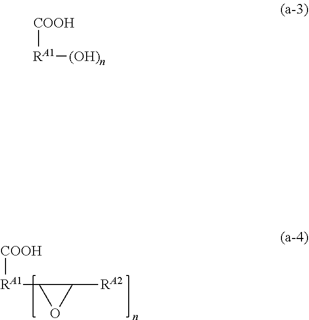

wherein:
R^{A1} is a saturated or unsaturated hydrocarbon chain having about 3 to about 24 carbon atoms, preferably about 10 to about 22 carbon atoms, more preferably about 12 to about 20, even more preferably about 17 carbon atoms. The number of double bonds may range from 0 to about 6, preferably 0 to about 3, more preferably 0 to about 2, even more preferably 0 or about 1, more preferably about 1. Since the double bonds have an influence on the subsequent oxidative crosslinking and thus worsen the biodegradability, a low number or absence of double bonds is advantageous. If double bonds are present, it is preferred that they are not conjugated.
R^{A2} is independently a hydrogen atom or a saturated or unsaturated hydrocarbon chain having from about 1 to about 24 carbon atoms, optionally including one or more epoxy groups; preferably a saturated or unsaturated hydrocarbon chain having from about 1 to about 18 carbon atoms, optionally including from about one to about six epoxy groups, more preferably a saturated or unsaturated hydrocarbon chain having from about 1 to about 16 carbon atoms, optionally including from about one to about four epoxy groups. In calculating the length of the hydrocarbon chain, the carbon atoms of the epoxy group are counted if they are in the chain (as shown above). If more than one epoxy group is present, they are usually linked by a methylene group.
n is at least 1, preferably about 1 to about 5, more preferably about 1 to about 4, even more preferably about 1 to about 3. When n>1 (i.e., more than one OH or epoxy group is present), the OH or epoxy groups may be attached to the same carbon atom or (preferably) to different carbon atoms of R^{A1}.

If several groups R^{A2} are included, they may be the same or different.

The fatty acid ester may have the formula (a-5) or (a-6)

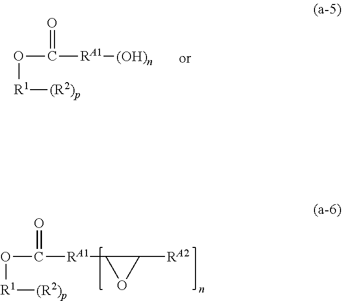

wherein
R^{A1}, R^{A2} and n are each independently as defined above,
R² is independently selected from —H, —OH, —O—CO—R^{A1},

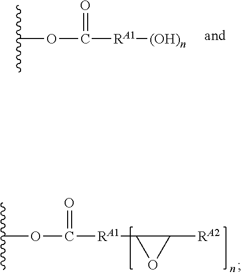

R¹ is selected from saturated, linear, branched or cyclic (preferably linear), aliphatic groups having about 2 to about 20, preferably about 2 to about 6, more preferably about 3 carbon atoms. R¹ may optionally contain about 1 or about 2 ether oxygen atoms, preferably no ether oxygen atoms are present; and
p is independently at least 1, preferably about 1 to about 5, more preferably about 1 to about 4, even more preferably about 1 to about 3, most preferably 2. When p>1 (i.e., more than one R² group is present), the R² groups may be attached to the same carbon atom or (preferably) to different carbon atoms of R¹. It is preferred that p does not exceed the number of carbon atoms in R¹ (i.e., if R¹ has 3 carbon atoms, p should be at most 3).

If multiple n, R^{A1}, R^{A2}, or R² are included, they may be the same or different.

Preferred fatty acid esters have at least about 2, preferably about 2 to about 6, more preferably about 2 to about 4, even more preferably about 3 hydroxyl groups per molecule.

In the fatty acid ester, at least about 1 hydroxyl or epoxy group, preferably at least about 2 hydroxyl or epoxy groups, more preferably all hydroxyl or epoxy groups of the polyhydric alcohol are attached to the fatty acid(s) (i.e., R² is

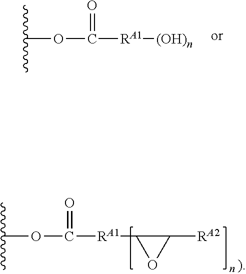

A preferred fatty acid has the formula (a-7) or formula (a-8), particularly preferably formula (a-7)

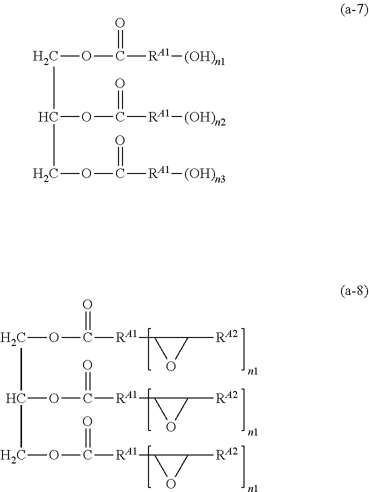

wherein R^{A1} and R^{A2} are independently as defined above.

n1 is at least 0, typically at least 1, preferably about 1 to about 5, more preferably about 1 to about 4, even more preferably about 1 to about 3.

n2 is at least 0, typically at least 1, preferably about 1 to about 5, more preferably about 1 to about 4, even more preferably about 1 to about 3.

n3 is at least 0, typically at least 1, preferably about 1 to about 5, more preferably about 1 to about 4, even more preferably about 1 to about 3.

n1+n2+n3 (i.e., the sum of all OH or epoxy groups) is at least 1, preferably about 1 to about 15, more preferably about 1 to about 12, even more preferably about 1 to about 9.

When n1>1, n2>1, or n3>1 (i.e., more than one OH or epoxy group is present), the OH or epoxy groups may be attached to the same carbon atom or different carbon atoms of R^{A1}.

If there are multiple R^{A1}, R^{A2}, or R² in formulae (a-5), (a-6), or (a-7), respectively, they may each be the same or different.

Mixtures of different compounds (A) can also be used.

Step (b-2): Providing a Compound (B) Selected from Compound (B-1) Having at Least Two Carboxyl Groups; and Compound (B-2) Having at Least One Cyclic Anhydride Group.

### Compound (B-1)

The compound (B-1) having at least two carboxyl groups (—COOH) is not particularly limited. It may, for example, be a dicarboxylic acid of the general formula (b-1)

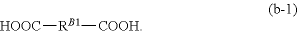

R^{B1} is selected from any organic group.

R^{B1} may be a saturated, branched or unbranched aliphatic group, a saturated cycloaliphatic group, aromatic hydrocarbon group optionally substituted with about 1 or about 2 alkyl groups, an unsaturated, branched or unbranched aliphatic group, or an unsaturated cycloaliphatic group.

R^{B1} may be a saturated, branched or unbranched C₂₋₁₆ (preferably C₂₋₁₄, more preferably C₂₋₁₂, even more preferably C₂₋₆) aliphatic group.

R^{B1} may be a saturated C₄₋₁₆ (preferably C₄₋₁₄, more preferably C₄₋₁₂, even more preferably C₄₋₆) cycloaliphatic group.

R^{B1} may be a C₆₋₁₆ (preferably C₆₋₁₀) aromatic hydrocarbon group optionally substituted with about 1 or about 2 C₁₋₄ alkyl groups.

R^{B1} may be an unsaturated, branched or unbranched, C₂₋₁₆ (preferably C₂₋₁₄, more preferably C₂₋₁₂, even more preferably C₂₋₆) aliphatic group.

R^{B1} may be an unsaturated C₄₋₁₆ (preferably C₄₋₁₄, more preferably C₄₋₁₂, even more preferably C₄₋₆) cycloaliphatic group.

The COOH groups shown may be attached to the same carbon atom or (preferably) to different carbon atoms of R^{B1}.

R^{B1} may optionally be substituted with further COOH groups and/or OH groups. R^{B1} may optionally be substituted with about 1 to about 6 further COOH groups and/or about 1 to about 6 OH groups. It is self-evident that the number of further COOH and OH groups is limited by the number of available binding sites.

Non-limiting examples of compound (B-1) comprise maleic acid, fumaric acid, succinic acid, terephthalic acid, isophthalic acid, adipic acid, glutaric acid, azelaic acid, o-phthalic acid, methyltetrahydrophthalic acid, methylhexahydrophthalic acid, furandicarboxylic acid, trimellitic acid, tricarballylic acid, trimesic acid, hemimellitic acid, pyromellitic acid, mellitic acid, malic acid, tartaric acid, meso-tartaric acid, racemic acid and citric acid. Trimellitic acid, succinic acid, maleic acid, methylhexahydrophthalic acid, isophthalic acid and phthalic acid are preferably used.

### Compound (B-2)

The compound (B-2) has at least one cyclic anhydride group.

Possible compounds (B-2) may have the formula (b-2):

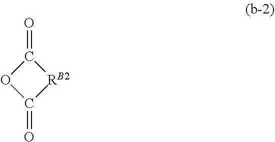

wherein R^{B2} is selected from a saturated C₂₋₆ aliphatic group, unsaturated C₂₋₆ aliphatic group, C₆₋₁₆ aromatic hydrocarbon group, saturated C₄₋₁₆ cycloaliphatic group, and unsaturated C₄₋₁₆ cycloaliphatic group.

R^{B2} may be a saturated, C₂-6 (preferably C₂₋₄) aliphatic group.

R^{B2} may be an unsaturated, C₂₋₆ (preferably C₂₋₄) aliphatic group.

R^{B2} may be a C₆₋₁₆ (preferably C₆₋₁₀) aromatic hydrocarbon group.

R^{B2} may be a saturated C₄₋₁₆ (preferably C₄₋₁₀) cycloaliphatic group.

R^{B2} may be an unsaturated C₄₋₁₆ (preferably C₄₋₁₀) cycloaliphatic group.

The two C═O units of the cyclic anhydride may be attached to the same carbon atom or (preferably) to different carbon atoms of R^{B2}R^{B2} may optionally have one or more substituents selected from —COOH, —C₁₋₄ alkyl, —OH, —NR*R*, —NR*H and —NH₂ (with R* being —C₁₋₄ alkyl).

Examples of preferred compounds (B-2) comprise succinic anhydride, maleic anhydride, phthalic anhydride, trimellitic anhydride, methyltetrahydrophtalic anhydride, methylhexahydrophtalic anhydride, tetrahydrophthalic anhydride, and hexahydrophthalic anhydride, more preferably succinic anhydride, phthalic anhydride, methylhexahydrophthalic anhydride, tetrahydrophthalic anhydride and hexahydrophthalic anhydride, most preferably trimellitic anhydride, maleic anhydride and methyltetrahydrophtalic anhydride.

Mixtures of compounds (B) with each other may also be used.

The ratio of compound (A) and (B) may vary and is preferably about 1 mol % to about 1.5 mol % to about 1 mol % to about 99 mol %. There is an advantage in an excess of compound (B), for example, because the epoxy-epoxy reaction is inhibited, and the crosslinking/hardness is improved.

Step (b-3): Reacting the Hydroxyl Group or Epoxy Group of Compound (A) with the Carboxyl Group or Anhydride Group of Compound (B) to Produce Compound (C) Having at Least One Ester Bond

Compound (A) is reacted with compound (B). The inventors presume, without being bound by this theory, that the hydroxyl group or epoxy group of compound (A) reacts with at least one of the carboxyl groups or with at least one of the anhydride groups of compound (B) to form an ester bond. In this process, the second or further carboxyl group of compound (B) is retained or a second carboxyl group is formed by the ring opening of the anhydride group.

When compound (B-2) has a carboxyl substituent, the ester bond may be linked between the hydroxyl group or epoxy group of compound (A) and the carboxyl group of compound (B-2). In this case, the anhydride group of compound (B-2) is retained. Alternatively, in this case, the ester bond may be linked between the hydroxyl group or epoxy group of compound (A) and the anhydride group of compound (B-2). In this case, the carboxyl group of compound (B-2) is retained and another carboxy group is formed by the ring opening of the anhydride group.

It is of course possible that the carboxyl groups formed by the reaction of compound (A) with compound (B) react with a further compound (A). In this case, a compound (C) is formed with another ester bond. The resulting compound (C) has a carboxyl group or anhydride group suitable for further reaction with compound (D) in step (d).

The compound (C) obtained in step (b-3) should preferably have at least two carboxyl groups or one anhydride group so that it can further react with compound (D) in the subsequent step (d).

The reaction is explained using the example of a compound (A), which has a hydroxyl group (n=1 or n1=1), in the following diagram

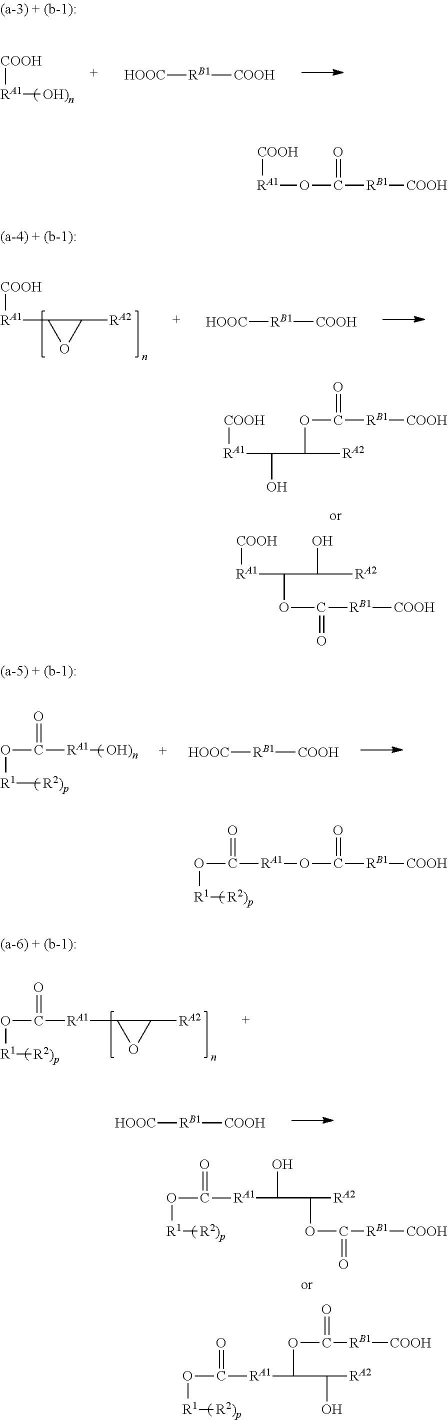

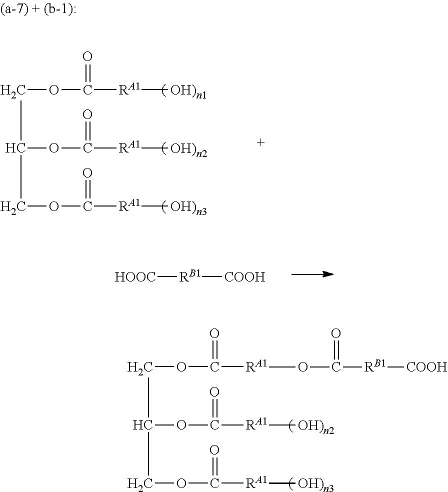

It is of course possible that not only one, but 2 or 3 OH groups may be esterified.

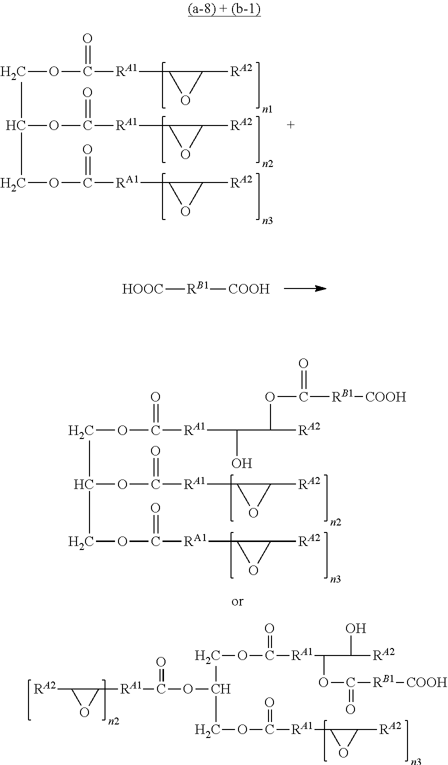

It is of course possible that not only one, but 2 or 3 epoxy groups can be esterified. In addition, the resulting ß-hydroxyl groups can be esterified by, for example, the ring opening of the oxirane by means of H₂O.

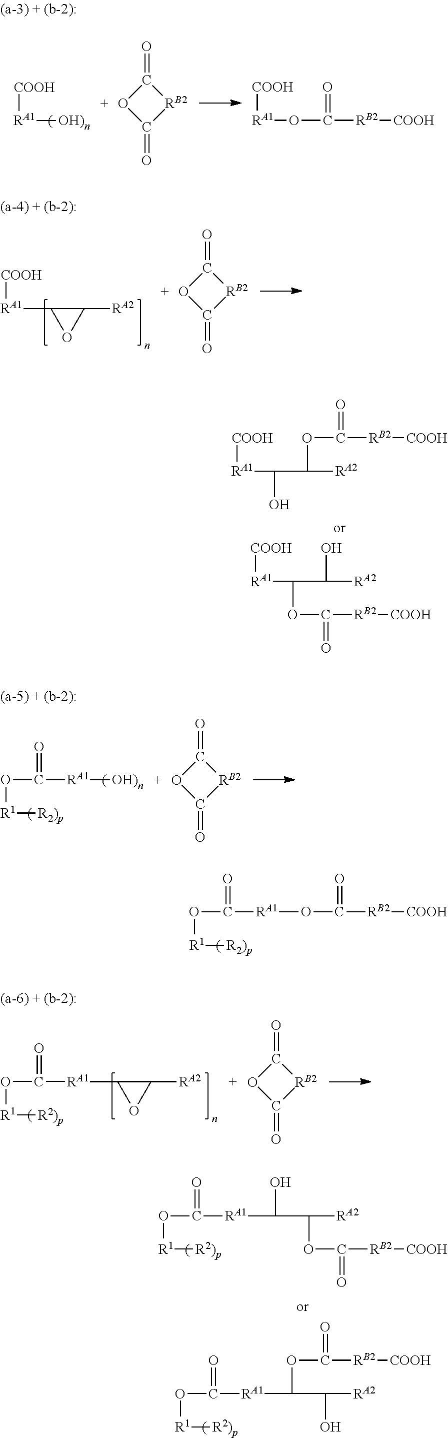

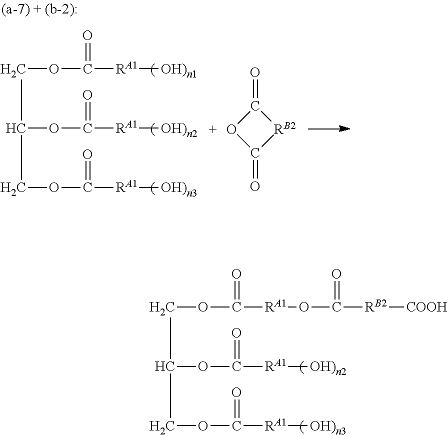

It is of course possible that not only one, but 2 or 3 OH groups can be esterified.

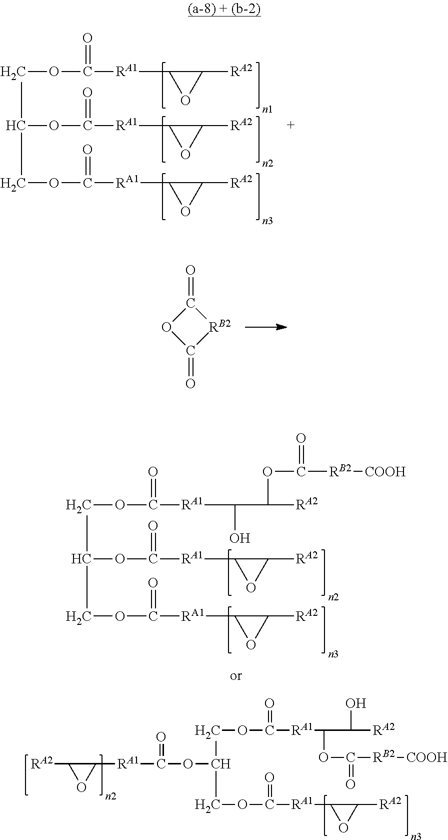

It is of course possible that not only one, but 2 or 3 epoxy groups can be esterified. In addition, the resulting ß-hydroxyl groups can be esterified by, for example, the ring opening of the oxirane by means of H₂O.

n, p, R¹, R², R^{A1}, R^{A2}, R^{B1} and R^{B2} are as defined above. It goes without saying that in the schemes shown, free OH or COOH groups can further react with additional (a-3), (a-4), (a-5), (a-6), (a-7), (b-1) and (b-2), respectively.

In the following reaction scheme, the presumed reaction of castor oil with trimellitic anhydride is shown:

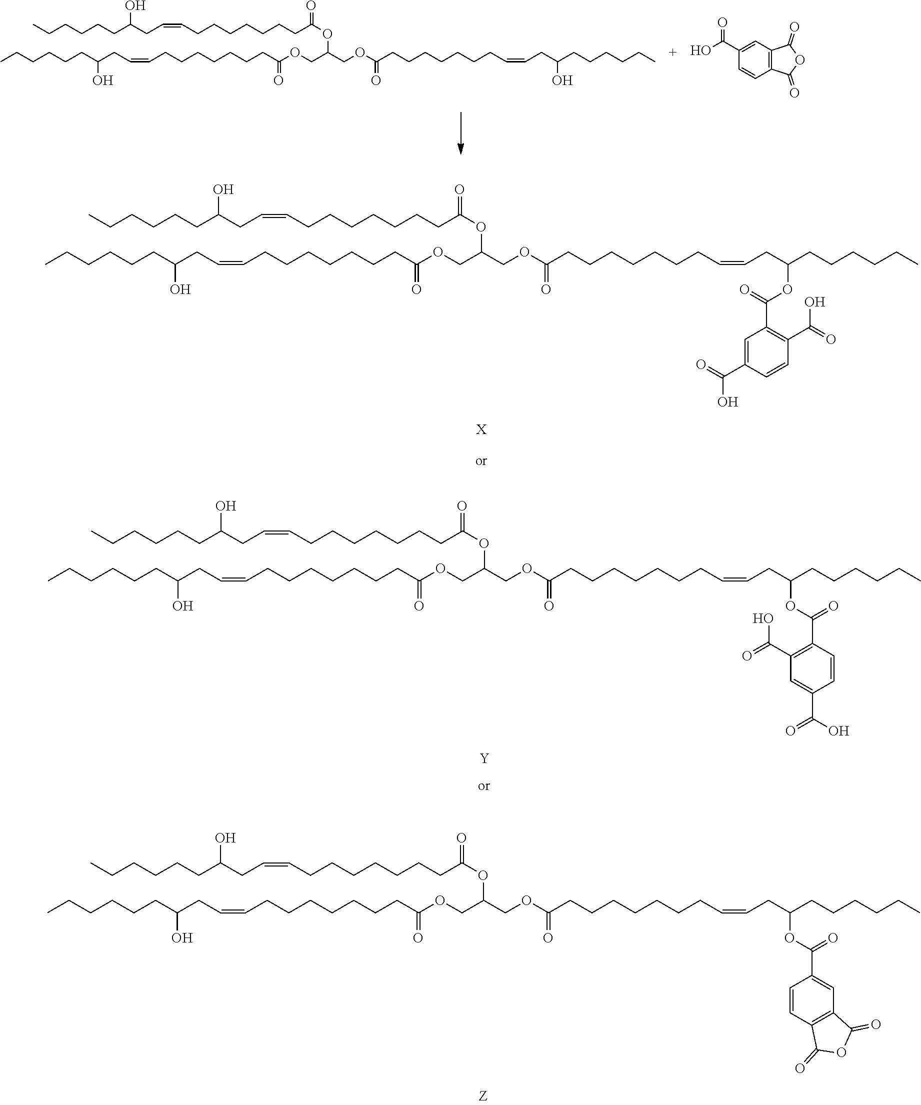

The reaction products X, Y and Z may be present in different or the same ratios. Furthermore, an increase in average molecular weight may occur by the further reaction of a free carboxyl or anhydride group with free hydroxyl groups. A spatially crosslinked polyester can be obtained hereby.

As shown in the FIGURE above, a polyvalent acid or the anhydride of a polyvalent acid, such as trimellitic anhydride (TMSA), can react in various ways. Esterification can occur either through both carbon atoms of the anhydride ring or through the free carboxyl group while retaining anhydride functionality. It is also conceivable to react hydrolyzed TMSA and form the ester bond via any carboxyl group.

The reaction of compound (A), which has an epoxy group, with compound (B) can be carried out directly or a ring opening can be carried out first, thereby forming two hydroxyl groups from the epoxy group.

Classical temperature ranges for the synthesis of component (C) are in the range of about 50° C. to about 270° C. The temperature is based on the melting point of the reactants used and may be reduced by using suitable solvents. If the reaction rate does not play a particular role, lower temperatures are also possible. The use of suitable esterification catalysts may also have an influence on the necessary reaction temperature.

The reaction according to the invention in step (b-3) differs from the reaction carried out, for example, in WO 02/096548. The reaction proceeding in WO 02/096548 is shown in the following scheme:

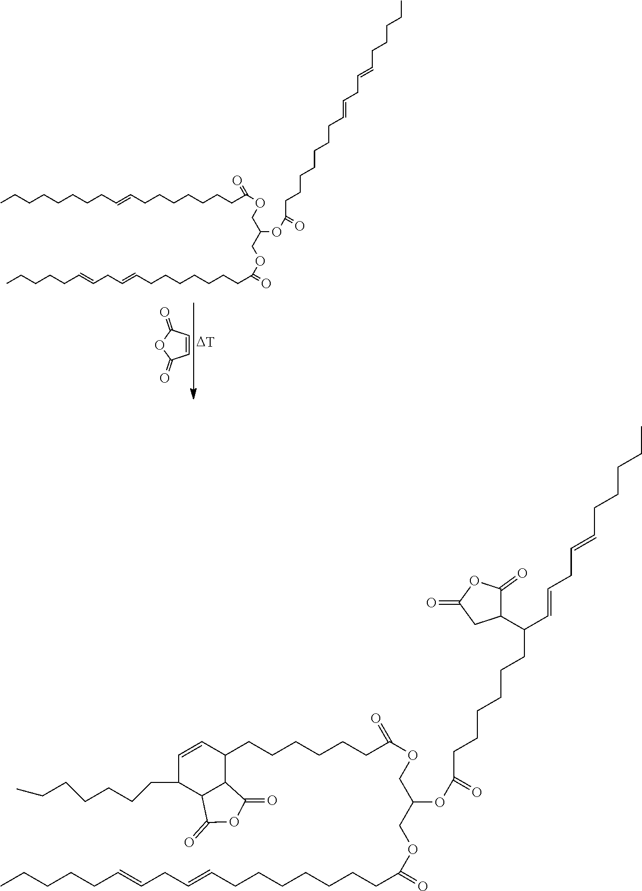

### Step (C): Providing a Compound (D) Having at Least One Epoxy Group

Compound (D) is not particularly limited, provided that it has at least one epoxy group on average to allow the formation of a polymeric network by the reaction with compound (C). The epoxy groups may be terminal or intermediate. The weight average molecular weight of compound (D) is typically in the range of about 200 to about 10000. The weight average molecular weight can be determined by HPLC (Agilent 1100, RI Detector, PSS SDV precolumn 5 μm, PSS SDV column 5 μm 1000 Å, PSS SDV column 5 μm 100 Å, eluent THF, column temperature 35° C., calibration against PSS Polystyrene ReadyCal kit low (Mp 266-67500 D), Internal Standard Polystyrene 700000.

The number of epoxy groups is at least about 1 epoxy group on average per molecule, preferably about 2 to about 18, more preferably about 3 to about 12.

The epoxy oxygen content may usually be in the range from about 1 to about 30, preferably from about 1 to about 20 wt. %. The epoxy oxygen content may be measured, for example, according to DIN 16945-1989-03.

Suitable compounds (D) may be selected from fatty acid esters of a monohydric or polyhydric alcohol and an epoxidized fatty acid, epoxidized fatty acid amides, esters of an epoxidized fatty alcohol, and ethers of an epoxidized fatty alcohol. Fatty acid esters of a monohydric or polyhydric alcohol and an epoxidized fatty acid are preferred.

### Fatty Acid Esters of a Monohydric or Polyhydric Alcohol and an Epoxidized Fatty Acid

Suitable monovalent alcohols include, for example, branched or unbranched C₁₋₆ alkanols, such as methanol, ethanol, iso-propanol, n-propanol, iso-butanol and n-butanol. Suitable polyhydric alcohols may be selected, for example, from saturated, linear or cyclic (preferably linear), aliphatic alcohols having about 2 to about 20, preferably about 2 to about 6, carbon atoms. The polyhydric alcohol may optionally contain about 1 or about 2 ether oxygen atoms, preferably no ether oxygen atoms are present. Preferred polyhydric alcohols have at least about 2, preferably about 2 to about 6, more preferably about 2 to about 4 hydroxyl groups per molecule. Specific examples include glycerol, ethylene glycol, diethylene glycol, propylene glycol, dipropylene glycol, neopentyl glycol, trimethylolpropane, pentaerythritol, dipentaerythritol, sugar alcohols (e.g., mannitol, isomalt, lactitol, sorbitol, xylitol, threitol, erythritol and arabitol) and cyclohexanediol. Glycerol is most preferred because triglycerides are widely and readily available. In addition, natural triglycerides are desirable as compound (D) especially in terms of biodegradability. It is also possible to use mixtures of polyhydric alcohols.

Monocarboxylic acids may be used as starting material of compound (D) as a fatty acid having an unsaturated hydrocarbon chain. For example, the hydrocarbon chain may have from about 3 to about 26 carbon atoms, preferably from about 5 to about 26 carbon atoms (preferably from about 10 to about 26 carbon atoms) (when determining the number of carbon atoms, the carbon atom of the carboxylic acid moiety is not counted). The number of double bonds may range from about 1 to about 6, preferably about 1 to about 4.

Examples of fatty acids comprise soybean oil, linseed oil, castor oil, dehydrated castor oil, sunflower oil, rapeseed oil, hemp oil, and fatty acid methyl esters, preferably soybean oil or linseed oil. It is self-evident that mixtures of the fatty acids may also be used. In one embodiment, used oil or used fat can be used, for example.

The fatty acids mentioned are epoxidized. Fatty acids are usually epoxidized by converting double bonds contained in the starting fatty acid into epoxy groups.

It is not necessary that each fatty acid has at least one epoxy group. Rather, it must be ensured that the compound (D) as a whole has at least one epoxy group. For example, if a triglyceride is used, each of the three fatty acid groups may have an epoxy group. The triglyceride as a whole then has 3 epoxy groups.

The fatty acid ester of a monohydric or polyhydric alcohol and a fatty acid may be obtained by first epoxidizing a fatty acid and then reacting the epoxidized fatty acid with the monohydric or polyhydric alcohol. Alternatively, the monohydric or polyhydric alcohol and the fatty acid may be reacted first, followed by epoxidation. Appropriate reaction conditions are known in the art.

A number of fatty acid esters are commercially available.

It is of course also possible to take natural triglycerides as starting material and subject them to epoxidation as above.

### Epoxidized Fatty Acid Amides

Fatty acid amides may be obtained by reacting an epoxidized fatty acid with NH₃, with a primary or secondary amine, with a primary or secondary diamine. The amine or diamine typically has about 1 to about 12, preferably about 1 to about 6, carbon atoms. Examples comprise methylamine, dimethylamine, methylethylamine, methyldiamine, and diethylamine.

Epoxidized fatty acids are defined as above for fatty acid esters.

The above epoxidized fatty acid may have the formula (d-1):

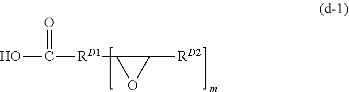

wherein:
R^{D1} is selected from a saturated or unsaturated hydrocarbon chain having from about 3 to about 26 carbon atoms, preferably from about 5 to about 26 carbon atoms (more preferably from about 10 to about 26 carbon atoms) (when determining the number of carbon atoms, the carbon atom of the carboxylic acid moiety is not counted). The number of double bonds may be from 0 to about 4, preferably 0 or about 1;
R^{D2} is independently a hydrogen atom or a saturated or unsaturated hydrocarbon chain having from about 1 to about 24 carbon atoms, optionally including one or more epoxy groups; preferably a saturated or unsaturated hydrocarbon chain having from about 1 to about 18 carbon atoms, optionally including from about one to about six epoxy groups, more preferably a saturated or unsaturated hydrocarbon chain having from about 1 to about 16 carbon atoms, optionally including from about one to about four epoxy groups, and
m is at least about 1, preferably about 1 to about 16, more preferably about 1 to about 9.

Compound (D) may preferably have formula (d-2) or (d-3):

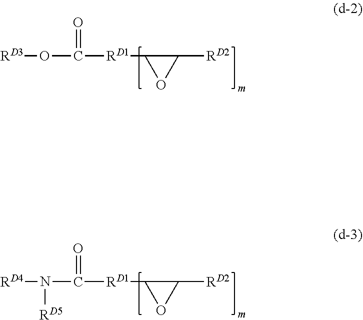

wherein
R^{D1} is selected from a saturated or unsaturated hydrocarbon chain having from about 3 to about 26 carbon atoms, preferably from about 5 to about 26 carbon atoms (more preferably from about 10 to about 26 carbon atoms) (when determining the number of carbon atoms, the carbon atom of the carboxylic acid moiety is not counted). The number of double bonds may be from 0 to about 4, preferably 0 or about 1.
R^{D2} is independently a hydrogen atom or a saturated or unsaturated hydrocarbon chain having from about 1 to about 24 carbon atoms, optionally including one or more epoxy groups; preferably a saturated or unsaturated hydrocarbon chain having from about 1 to about 18 carbon atoms, optionally including from about one to about six epoxy groups, more preferably a saturated or unsaturated hydrocarbon chain having from about 1 to about 16 carbon atoms, optionally including from about 1 to about 4 epoxy groups.
R^{D3} is selected from saturated, branched or unbranched, linear or cyclic (preferably linear), aliphatic C₁₋₂₀ alkyl groups (preferably C₂₋₆), optionally containing about 1 or about 2 ether oxygen atoms (preferably no ether oxygen atoms are present). R^{D3} may optionally include at least about 1, preferably about 1 to about 5, more preferably about 1 to about 3 hydroxyl groups or further

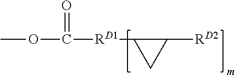

groups per molecule.
R^{D4} is selected from H and C₁₋₁₂ alkyl (preferably C₁₋₆ alkyl), wherein alkyl may optionally be substituted with NH₂.
R^{D5} is selected from H and C₁₋₄ alkyl.
m (i.e., the sum of all epoxy groups) is at least 1, preferably about 1 to about 16, more preferably about 1 to about 9.

If there is more than one m, R^{D1} or R^{D2}, R^{D1}, R^{D2} and m may each be the same or different.

In a more preferred embodiment, compound (D) has formula (d-4).

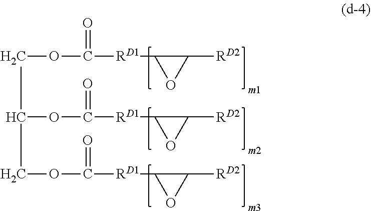

wherein R^{D1} and R^{D2} are as defined above, and R^{D1} and R^{D2} may each be the same or different.

m1 is at least 0, typically at least 1, preferably about 1 to about 16, more preferably about 1 to about 9.

m2 is at least 0, typically at least 1, preferably about 1 to about 16, more preferably about 1 to about 9.

m3 is at least 0, typically at least 1, preferably about 1 to about 16, more preferably about 1 to about 9.

m1+m2+m3 (i.e., the sum of all epoxy groups) is at least about 1 on average per molecule, preferably about 1 to about 48, more preferably about 1 to about 27.

Mixtures of compounds (D) are also possible.

Step (d): Reaction of Compound (C) with the Epoxy Group of Compound (D) to Produce a Compound (E) Having an Ester Bond;
Wherein the Reaction of Compound (C) with Compound (D) Takes Place in the Presence of the Granular Material to Provide a Coated Granular Material

The procedure for step (d) is not particularly limited. In one embodiment, the granular material may first be provided and optionally be preheated to a temperature of about 50 to about 150° C., preferably about 80 to about 130° C., prior to addition of the coating material.

It is preferred to keep the granular material to be coated in motion throughout the whole coating process. This can be done, for example, by agitating, shaking or moving the coating apparatus. The coating may be done in any suitable apparatus such as a rotating drum, a fluidized bed apparatus, a tubular apparatus in which the coating is done either by rotation of the tube and/or by rotating internals. Likewise, a continuous coating process with a screw conveyor is possible. In fluidized bed processes, a fluidized bed of the granular material is created with a fluidizing gas and then the coating material is introduced into the fluidized bed. Such fluidized bed coating processes are described, for example, in U.S. Pat. No. 5,211,985. The coating is most easily carried out in a rotating drum, in which the material to be coated is kept in motion throughout the whole coating process.

To create the coating, compound (C) and compound (D) are added to the granular material. Compound (C) and compound (D) may either be premixed and then added to the granular material, or compound (C) and compound (D) may be added separately (simultaneously or sequentially) to the granular material.

The coating material can be added to the granular material continuously or in portions. The added portions may comprise equal or different amounts of coating material. It is preferred to wait until the amount of coating material added in the previous step has been distributed as uniformly as possible on the granular material before adding the next portion of coating material. Depending on the temperature and the amount and type of coating material and granular material used, this may include a period of time of, for example, about 1 to about 10 minutes. Continuous addition may typically take a period of time of about 15 to about 150 minutes.

The amount of coating material added is not essential and may be applied continuously or discontinuously to the substrate to be coated. From an economic point of view, however, it is desirable to use as small an amount of coating material as possible. At the same time, however, it should still be possible to produce a functioning coating on the granular material with this amount. In a preferred embodiment, the granular material to be coated is substantially coated completely. Typically, compound (E) is used in an amount of about 3 to about 40% by weight, preferably about 5 to about 30% by weight, based on the granular material to be coated. The amount of coating material may also be used to control the rate of release of the substance from the coated granular material.

In step (d), compound (C) is reacted with compound (D) to produce compound (E) having an ester bond. It is assumed that the carboxyl group or anhydride group contained in compound (C) reacts with the epoxy group of compound (D) to form a polymeric network.

The following reaction outlines the possible ester formation between compound (C) and compound (D). Further crosslinking of the oxirane rings with, for example, other available carboxyl, hydroxyl or anhydride groups leads to polymer formation, so that the product shown is a fragment of the polymer.

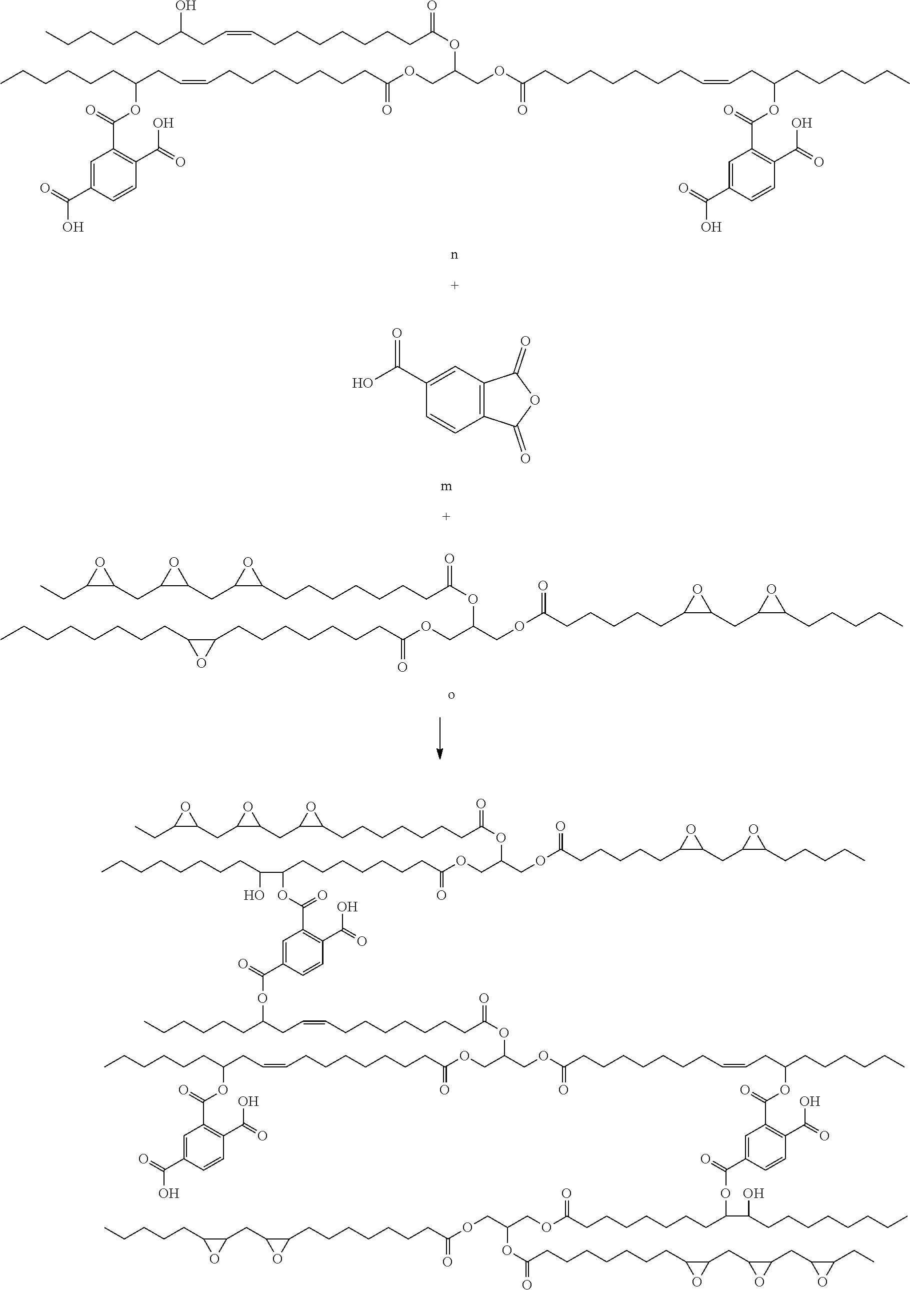

As can be seen from the depiction, residual monomers of the acid or anhydride component used may be present in component C. These residual monomers may also react according to the attached reaction scheme. The proportion of these residual monomers may range from 0% to 40%, preferably in the range from 0% to 30%, particularly preferably from 0% to 15%.

Other additives may be added to the coating material if desired, such as catalysts, modifiers, water repellents, fillers, or other ingredients favorable to the particular application of a particular coated granular material. If plant additives are to be incorporated into the coating, they may be charged before, during or after the coating material is added.

In principle, all common water repellents may be used as modifiers or water repellents. Inorganic and/or organic and/or inorganic-organic hybrid systems are possible. Natural waxes are suitable here because of their degradability. These include, among others, beeswaxes, candelilla wax, carnauba waxes, rice husk waxes, sunflower wax, palm waxes, soy waxes, coconut waxes, rapeseed waxes and also other natural fats and waxes, such as wool fat or jojoba oil. Mixtures of the afore-mentioned waxes or other biodegradable fat, wax and oil products and mixtures thereof may also be combined for the specific application, so that advantages are shown, for example, in the coating process or in the barrier effect. This includes optimizing the melting point or the melting range of the additives or additive blends, as well as adjusting the viscosity or other flow and leveling properties.

Pure vegetable oils are also conceivable, wherein (hardened) vegetable oils that cannot undergo oxidative post-crosslinking should preferably be used, as well as mixtures with each other and with the above-mentioned waxes.

Inorganic water repellents are, for example, zeolites and silicates. Suitable hybrid systems are, for example, organically modified silicates or hydrophobized silicas.

In principle, mixtures of organic and/or inorganic and/or inorganic-organic hybrid systems may also be used.

The addition of the optional additives may be conducted in combination with compound (C) and/or with compound (D). Alternatively, the addition may be carried out with the mixture of compound (C) and compound (D), for example to achieve the most homogeneous distribution of the additive in the coating. The addition of the optional additives may also be carried out separately from compound (C) and compound (D). The addition in an intermediate step or for post-treatment of the coated granular material is also useful for varying the properties of the coating.

Compound (C) and/or compound (D) may be introduced into the coating apparatus in a solvent, if desired. Examples of suitable solvents include esters such as methoxypropyl acetate. Solvent combinations with common solvents such as solvent naphtha, butyl acetate, dibasic ester and TEOS are also possible. The amount of solvent is not limited and can range, for example, from about 10 to about 95 wt.-%.

The curing of the coating material can be controlled, for example, by increasing the temperature or adding catalysts. The process is typically carried out at a temperature of about 50 to about 150° C., preferably about 80 to about 130° C. Suitable catalysts include those commonly used in the art for catalyzing reactions between the epoxy group and the carboxyl group or anhydride group. These include nitrogen-containing catalysts, such as tertiary amines, imidazoles and derivatives thereof, nitrogen-containing heterocycles, polyimidazoles and copolymers of imidazole and suitable comonomers, dicyanamide, quaternary ammonium compounds, Lewis acids such as boron trifluoride derivatives, ferric chloride, aluminum chloride, zinc chloride, and calcium or magnesium salts of fatty acids, such as calcium or magnesium stearate, and mixtures of at least 2 components with each other. The use of simple acids such as phosphoric acid, hydrochloric acid, sulfuric acid, para-toluenesulfonic acid or methanesulfonic acid is also possible for curing. The use of an active metal ion in combination with ligands that enable the formation of ester structures is also conceivable (e.g. nitrogen-containing metal complexes such as phthalocyanine derivatives of Fe(Ill) complexes).

Iron(III) chloride is particularly preferred as a catalyst. For example, ferric chloride hexahydrate is dissolved in a suitable solvent such as methoxypropyl acetate. The solvent should be compatible with the solvents of compound (C) and compound (D). The amount of ferric chloride hexahydrate in the solvent is typically from about 1 to about 95% by weight, preferably from about 5 to about 80% by weight, and more preferably from about 7 to about 50% by weight, and particularly preferably from about 10 to about 30% by weight, each based on the weight of the solvent and the ferric chloride hexahydrate.

The addition of the catalyst is variable. Thus, the catalyst may be introduced with compound (C) and/or with compound (D). It is also possible to introduce the catalyst with the mixture of compound (C) and compound (D). Alternatively, the catalyst may be introduced separately from compound (C) and compound (D). It may be advantageous to first introduce the granular material, compound (C) and compound (D) and then introduce the catalyst when compound (C) and compound (D) are sufficiently mixed with the granular material. Preferably, the amount of catalyst relative to the amount of compound (C) and compound (D) is from about 0.10 wt % to about 10 wt %. Particularly preferably, the amount of catalyst is from about 0.25 wt % to about 7 wt %.

The coating of the granular substance may be composed of more than one layer of the cured coating material, and the layers may each have the same or different layer thicknesses, and each be partially or completely enveloping. However, the coating as a whole should be as completely enveloping as possible in order to prevent premature or too rapid release of the granular material or the active ingredient contained in the granular material. To apply several layers, step (d) can be repeated once or several times.

It is preferred that compound (A) and/or compound (B) and/or compound (D) are biodegradable.

It is also preferred that compound (A) and/or compound (B) and/or compound (D) are of natural origin to improve environmental compatibility. It is more preferred that compound (A) and/or compound (B) and/or compound (D) are obtained from renewable raw materials.

The coating is preferably permeable to water or water vapor in both directions. The coated granular materials of the present invention are therefore characterized by a uniform release of active ingredient. Depending on the thickness and type of coating, it is possible to produce, for example, a fertilizer granule with an effective period of from one month to two years. The coating also exhibits good mechanical properties. A further advantage of the coated granular materials according to the invention is that the coating can be based predominantly on renewable raw materials and is thus ecologically preferred.

The coated granular material according to the invention preferably has a biodegradability of at least about 20% after 180 days, more preferably at least about 30%, even more preferably at least about 40%. Biodegradability can be determined, among other things, as described in the example section, using an ER12/L respirometer (ECHO, d.o.o.).

The process is suitable for coating virtually all types of granular materials. However, the particular advantages of the process are especially apparent in the case of completely or partially water-soluble granular materials. The process can be carried out at relatively low temperatures and in the absence of undesirable solvents.

### EXAMPLES

The invention is illustrated by the following non-limiting examples.

Unless otherwise stated, percentages refer to percent by weight.

### Example 1: Maleic anhydride Castor Oil Adduct (Compound C-1)

In a 4-liter four-neck flask equipped with reflux condenser/distillation bridge, thermometer and KPG stirrer, 2661.29 g of castor oil and 838.71 g of maleic anhydride were weighed and heated to 125° C.+/−5° C. under stirring and reflux in a nitrogen atmosphere. The reaction mixture was kept at this temperature for 0.5 h. An acid number of about 146 mg KOH/g resin was approached and a viscous, clear, yellowish product was obtained.

### Example 2: Trimellitic anhydride Castor Oil Adduct (Compound C-2)

In a 4-liter four-neck flask equipped with reflux condenser/distillation bridge, thermometer, and KPG stirrer, 933.45 g of castor oil and 576.39 g of trimellitic anhydride were weighed and heated to 190° C.+/−5° C. under stirring and reflux in a nitrogen atmosphere. The reaction mixture was kept at this temperature for 3 h. An acid number of about 240 mg KOH/g resin was approached and a viscous, clear, brown product was obtained.

### Example 3: Castor Oil-glycerol-maleic anhydride Adduct (Compound C-3)

In a 4-liter four-neck flask equipped with reflux condenser/distillation bridge, thermometer, and KPG stirrer, 933.45 g of castor oil, 41.96 g of lithium hydroxide monohydrate, 92.09 g of glycerol, and 98.06 g of maleic anhydride were weighed and heated to 190° C.+/−5° C. under stirring in a nitrogen atmosphere. The reaction mixture was kept at this temperature for 5 h. A low viscosity, yellowish product was obtained.

### Example 4: Polyol maleic anhydride Adduct (Compound C-4)

In a 4-liter four-neck flask equipped with reflux condenser/distillation bridge, thermometer, and KPG stirrer, 1145.16 g of compound C-3 and 354.84 g of maleic anhydride were weighed and heated to 125° C.+/−5° C. under stirring in a nitrogen atmosphere. The reaction mixture was kept at this temperature for 2 h. A viscous, clear, brown product was obtained.

### Example 5: Polyol trimellitic anhydride Adduct (Compound C-5)

In a 4-liter four-neck flask equipped with reflux condenser/distillation bridge, thermometer and KPG stirrer, 877.00 g of compound C-3 and 219.25 g of trimellitic anhydride were weighed and heated to 190° C.+/−5° C. under stirring in a nitrogen atmosphere. The reaction mixture was kept at this temperature for 6 h. A viscous, clear, brown product was obtained. This product contains about 20% trimellitic anhydride. Polyol-trimellitic anhydride adducts containing 25%, 30% and 35% trimellitic anhydride were prepared analogously. The adducts were tested in Example 16.

### Example 6 (Reference Example): —Maleinated Soybean Oil—Reference According to Patent Application EP 1 392 422 A

In a 4-liter four-neck flask equipped with reflux condenser/distillation bridge, thermometer and KPG stirrer, 1300.00 g of soybean oil and 433.33 g of maleic anhydride were weighed and heated to 200° C.+/−5° C. under stirring in a nitrogen atmosphere. The reaction mixture was kept at this temperature for 6 h. A viscous, clear, brown product was obtained.

### Example 7: Preparation of the Catalyst Solution (Cat B)=Solution of Cat a with a Suitable Solvent

To prepare the catalyst solution (Cat B), 20 g of ferric chloride hexahydrate (Cat A) were dissolved in 80 g of methoxypropyl acetate and provided for use.

### Example 8: Curing trimellitic anhydride Castor Oil Adduct (Compound C-2) with Epoxidized Linseed Oil (Compound (D)) to Evaluate the Films

Compound C-2 was diluted 1:1 in methoxypropyl acetate and mixed together with epoxidized linseed oil (available from HOBUM Oleochemicals GmbH, undiluted) in a ratio of 50:50 (w/w) based on compounds (C) and (D). Catalyst solution Cat B was then added at 5% to the weight of compounds (C) and (D) and all components were vigorously mixed.

For simple film experiments, 20 g of compound (C) was mixed with 10 g of compound (D) in a disposable paper cup (200 mL) using a wooden spatula (tongue depressor). Shortly thereafter, 1 mL of the 20 wt % catalyst solution Cat B was stirred in. To evaluate and test films, about 3 to 5 mL of the mixture was taken with a disposable pipette and applied to a cleaned glass plate (10×10 cm, 3 mm thickness) and drawn up with 90 μm wet film thickness with a doctor blade and then cured at 100° C. in a drying oven for, e.g., 30 min to obtain a tack-free film. Films mounted in this way could be evaluated optically as well as according to typical film testing criteria from the coatings industry. These include early water resistance or pendulum damping according to König.

### Example 9

Biodegradability Tests in Accordance with DIN EN ISO 14855-1:

Finished compost from a composting plant was purchased for the biodegradability tests. The compost had the following non-binding values taken from the product data sheet:

| Property (at 42% humidity) | Value | Unit |
|---|---|---|
| Grain size | | |
| Bulk density | 0.71 | t/m³ |
| Degree of rotting | 5 | |
| pH value | 8.4 | |
| Salinity | 3.00 | g/l |
| C/N ratio | 18 | |
| Organic substance | 33.5 | % |
| Nitrogen N | 1.09 | % |
| Phosphate P₂O₅ | 0.48 | % |
| Potassium oxide K₂O | 0.95 | % |
| Magnesium oxide MgO | 0.96 | % |
| Zinc Zn | 0.02 | % |

### Materials Used for the Biodegradability Studies:

Microcrystalline cellulose (CAS: 9004-34-6; molecular weight 342.3 g/mol; M-Clarity™ quality level=MQ100; Sigma Aldrich) was taken as the reference substance.

The coatings to be investigated were applied to H31 sand (Quarzwerke GmbH) and allowed to react. For this purpose, 3 kg of sand were coated stepwise or continuously with a premix of compound (C), compound (D) and catalyst solution B (20 parts FeCl₃×6H₂O in 80 parts methoxypropyl acetate) at 100+/−5° C. The coating materials were reacted out at a given temperature by stirring together selected weight ratios of compound (C) and compound (D) and adding the catalyst. For example, compound (C) and compound (D) were stirred together in a 50:50 weight ratio of pure components with 1% catalyst (Cat A) and reacted on the sand grains. A coating degree of the sand of, for example, 5% or 10% (weight of the coating based on the weight of the sand) was aimed for. The actual degree of coating can be checked by determining the loss on ignition. After successful coating, the coated sand was in a free-flowing state, so that each sand grain had a thin resin layer. Due to the small size of the sand grains and the low degree of coating, the coated sand had a high surface area, and it can be assumed that this increased surface area compared to a polymer film in one piece is conducive to improving the biodegradation rate.

Various resins were applied to the surface of sand grains. As examples of biodegradability, the following coated sands are listed below. The different ratios of compound (C) to compound (D) occurred for Example 2 and the reference according to patent application EP 1 392 422 A due to the different anhydride and acid functionality, respectively.

| | | | | Loss on |
|---|---|---|---|---|
| | Compound | Compound | | ignition of |
| | (C) | (D) | Cat A | coated H31 |
| | [wt %] | [wt %] | [wt %] | samples |
| Ester comp. (C-1) | 49.5 | 49.5 | 1 | 4.9% |
| Example 1 | | | | |
| Ester comp. (C-2) | 49.5 | 49.5 | 1 | 5.0% |
| Example 2 | | | | |
| Reference according | 69.3 | 29.7 | 1 | 9.1% |
| to patent application | | | | |
| EP 1 392 422 A | | | | |
| (C-7) | | | | |

The following materials can be use as aggregates for better aeration of the soil:
FloraSelf—expanded clay (Floragard Vertriebs-GmbH)
Seramis®—growing medium (Seramis GmbH)
Edasil® Agricultural Bentonite (OSCORNA-DÜNGER GmbH)

### Description of the Measuring Device Set-Up and Procedure for the Determination of Biodegradability

The biodegradability studies were performed in a respirometer ER12/L (ECHO, d.o.o.), consisting of a control unit, a temperature-controlled sample chamber (refrigerator), 12 sample containers, and a PC for automatic recording of the measured experimental conditions (time, temperature, gas flow rates, CO₂ and O₂ concentrations, relative humidity, and air pressure).

The respirometer was operated with a diaphragm pump to supply fresh air or connected to a compressed air line with pressure reducer. The inlet pressure was regulated to about 0.4 bar via a pressure reducer with oil separator on the compressed air line. Ambient or compressed air entered the unit filtered and exited through another filter. The maximum overpressure was set at 600 mbar. The flow through the samples was controlled by a mass flow controller. One measurement channel ran separately from the sample vessels as a control of the air passing through. The other measurement channels were at the 12 sample vessels. Air from the sample vessels was allowed to condense and the condensate was then pumped back into the sample vessels by a peristaltic pump. This kept water loss to a minimum. Only one channel could be measured at a time, so the air from the other measuring channels escaped directly through the filtered outlet. In front of the analyzer was a condensate trap with condensate return, which thus protected the sensors from moisture. In addition, a tube made of protonated PTFE (Nafion) protected the sensors by further reducing the humidity to ambient values.

### Description of the Biodegradability Method:

In the sample containers with a capacity of 3 liters, a compost sample was filled for each test series to determine the background respiration of the soil, a reference sample with confirmed biodegradability (cellulose) and the desired number of samples. Here, crystalline cellulose in powder form was added to the compost and resin samples cured on sand grains were also mixed with the compost as samples.

The compost was sieved through a mesh screen with the width of about 0.4 mm and adjusted with water to a dry residue of 50 to 55%. The coatings to be tested were reacted out on H31 sand at 100° C. so that the coated sand samples had a coating degree of about 5 to 10% (+/−2%). According to the dry weight or loss on ignition, 30 g of organic material (cellulose or reacted resin) were mixed with 400 g of compost. The coated sand weight was in the range of 638 g at a coating level of 5% and 30 g target weight for the added organics. Soil moisture was adjusted so that the soil lost liquid when pressed against the glass wall. For better aeration (good for aerobic degradation), 50 g of expanded clay and 50 g of Seramis were added to each vessel as inert fillers. This facilitated uniform aeration of the sample material with fresh air throughout the measurement period.

| Days in respirometer | 10 | 30 | 60 | 120 | 180 | 240 | 300 |
|---|---|---|---|---|---|---|---|
| Cellulose | 16.6% | 57.6% | 71.6% | 77.1% | 76.6% | 75.2% | 74.6% |
| Coating with ester | 4.2% | 10.6% | 25% | 44.1% | 51.7% | 56.1% | 59.5% |
| component (C-1) Example 1 | | | | | | | |
| Coating with ester | 3.0% | 7.7% | 20.3% | 37.2% | 50.1% | 54.5% | 56.9% |
| component (C-2) Example 2 | | | | | | | |
| Reference according to | 2.2% | 3.9% | 5.9% | 10.2% | 15.6% | 23.5% | 32% |
| patent application | | | | | | | |
| EP 1 392 422 A (C-7) | | | | | | | |

As can be seen from the table, the examples according to the invention exhibit significantly improved biodegradability. The inventors presume that this can be attributed to the avoidance of double bonds.

### Example 10

The table below shows the curing times of the films wet-applied with 60 μm on aluminum plates and the resulting pendulum damping of the films after 20 min curing at 100° C. and subsequent cooling to room temperature. The curing time gives an indication of the reactivity of the coating and the pendulum damping gives an initial indication of the robustness of the coating.

The curing time could be reduced to 4 minutes. The pendulum damping could also be increased.

| | | | König pendulum |
|---|---|---|---|
| | | Curing time | damping 6°-3° |
| | Mixing ratio | [min] | [s] |
| Coating with ester | 50:50 | 7 | 15 |
| component (C-1) | | | |
| Coating with ester | 50:50 | 4 | 18 |
| component (C-2) | | | |
| Reference according to | 70:30 | 17 | 12 |
| EP 1 392 422 A (C-7) | | | |

### Example 11: Fertilizer Coating with Compound (C-1)

The fertilizer to be coated (NPK fertilizer (MgO, S) with trace nutrients 12+12+17 (+2+8) from RWZ (Raiffeisen Waren-Zentrale Rhein-Main eG)) was preheated to 100° C. in a drying oven and transferred to a coating machine (Mohmeyer Model L 5). There, the angle of inclination of the rotation axis was set to 35° C. and the rotation speed to approximately 28 to 30 rpm. The boiler was heated from below with a hot air gun (Steinel HG 2320E, Steinel Vertrieb GmbH) so that the coating process could take place at 100° C.±5° C. Likewise, through the opening of the boiler with another hot air gun (identical in construction), the granular material was fed with hot air so that the coating temperature could be maintained after the premix from the resin components had been fed. The coating of the fertilizer granules proceeded in five steps and a total blending of 10% on the mass of the granules used. 2000 g of NPK fertilizer was fed, so the individual coating steps were designed to add 40 g of pure resin. Compound (C-1) was diluted 1:1 in methoxypropyl acetate and then mixed 2:1 with compound D and 5% catalyst solution Cat-B. This premix was added to the rotating NPK fertilizer and allowed to react. Curing took place in a few minutes. Once the fertilizer granules appeared tack-free and dry, the next layer was applied and allowed to react. After five coats, the coated fertilizer was held at this temperature for an additional 10 minutes before being cooled and stored in internally coated cans until further processing.

### Example 12: Fertilizer Coating with Compound (C-2)

As in Example 11, the coating was carried out with compound (C-2). As a premix, compound (C-2) was now diluted 1:1 in methoxypropyl acetate and then mixed at a ratio of 2:1 with compound (D) and 5% Cat-B catalyst solution. The coating of the granules was also carried out in five steps.

### Example 13: Fertilizer Coating with Reference According to EP 1 392 422 a (C-7)

As in Example 11, the coating was carried out with compound C-7. As a premix, compound (C-7) was now slightly diluted 7:3 in solvent naphtha and then mixed with compound (D) and 5% catalyst solution Cat-B at a ratio of 127:30 of the pure components. The coating of the granules was also carried out in five steps.

### Example 14: Determination of the Active Ingredient Release of Coated NPK Fertilizer at Room Temperature (Cold Leaching)

The coated fertilizer granules of Examples 11 to 13 were tested for their release property by cold leaching. For this purpose, 10 g of coated granules were weighed into a tea filter bag and immersed in a 1 l wide neck amber glass bottle containing 850 ml of demineralized water. Samples were stored in a drying cabinet under standard climate conditions (23° C., 50% relative humidity) and shaken briefly and gently before measurement. The increase in conductivity was determined regularly using a conductivity meter (GMH3431, GHM Messtechnik GmbH).

| | Coated fertilizer | Coated fertilizer | Coated fertilizer |
|---|---|---|---|
| | granules according | granules according | granules according |
| | to Example 11 | to Example 12 | to Example 13 |
| Time in | Conductivity | Conductivity | Conductivity |
| days | [mS/cm] | [mS/cm] | [mS/cm] |
| 0.0 | 0.2 | 0.2 | 0.2 |
| 0.5 | 0.3 | 0.3 | 0.2 |
| 5.8 | 10.3 | 2.8 | 2.2 |
| 6.9 | 11.3 | 3.8 | 3.3 |
| 8.1 | 12.0 | 4.9 | 4.3 |
| 8.8 | 12.3 | 5.6 | 5.2 |
| 11.8 | 12.8 | 6.9 | 6.3 |
| 20.0 | 13.4 | 9.5 | 6.7 |
| 23.0 | 13.6 | 10.2 | 7.6 |
| 40.9 | 14.0 | 12.7 | 8.3 |

Based on the cold leaching values, it is evident that a barrier effect is present. This leads to a delayed release of nutrients compared to uncoated granules. This property can be used for the production of controlled release fertilizer. Although the barrier effect of the composition according to the invention does not exceed the barrier effect of the reference example, the biodegradability in compost could be proven. The biodegradability of the reference example is significantly lower. Thus, the example according to the invention provides the best compromise between release properties and biodegradability.

### Example 15: Additive Addition of Component (D)

The properties of the resin coatings can be further improved so that the release of nutrients is slower. Additives can be used for this purpose. An example is the use of beeswax, which can be stirred into component (C) or component (D). For this series of tests, beeswax was stirred into component (D) as an additive. The mean values of the duplicate determinations for the cold leaching tests are shown below as absolute leaching based on the last measured value of conductivity after 49 days of the individual coated fertilizer granules. The total amount of beeswax was varied between 0 and 7.5%.

Epoxidized linseed oil is blended with varying amounts of beeswax from 0.0 to 15.0% by weight based on epoxidized linseed oil. The mixing ratio of component (C) with the mixture of beeswax with component (D) was 1:1 and results in the wax contents in the cured resin layer (E) listed in the table below.

| Days/ | | | | | | | | | |
|---|---|---|---|---|---|---|---|---|---|
| Proportion of | Leaching of nutrients from coated fertilizer granules in % | | | | | | | | |
| wax in the film | 0.00% | 0.25% | 1.00% | 1.50% | 2.00% | 2.50% | 4.00% | 5.00% | 7.50% |
| 1 | 1.36 | 1.63 | 0.12 | 0.15 | 0.15 | 2.10 | 0.22 | 0.52 | 0.11 |
| 8 | 11.49 | 18.52 | 2.82 | 1.83 | 2.24 | 7.61 | 1.63 | 4.83 | 0.83 |
| 17 | 70.96 | 76.83 | 33.64 | 28.08 | 23.13 | 52.41 | 13.66 | 30.45 | 4.83 |
| 27 | 88.36 | 90.10 | 82.20 | 83.01 | 83.61 | 88.85 | 77.40 | 81.86 | 71.27 |
| 34 | 94.44 | 95.38 | 91.37 | 92.38 | 93.04 | 94.89 | 90.31 | 92.19 | 85.15 |
| 49 | 100.00 | 100.00 | 100.00 | 100.00 | 100.00 | 100.00 | 100.00 | 100.00 | 100.00 |

### Example 16: Comparison of Pendulum Damping of Coatings Made from Components (C) and (D) with Different Acid Contents and Ratios

The determination of the pendulum damping according to König (according to DIN 53 157) provides information on the plastic-elastic behavior of a coating. The pendulum damping can be used as an indication of the load-bearing capacity of a coated fertilizer granulate.

Furthermore, it is possible to adjust the desired mixing ratio of component (C) to component (D) if the results of pendulum damping are combined with other test results, such as the release property in Example 15 or mechanical abrasion resistance in the coating process.

To determine the pendulum damping, components (C) and (D) were mixed with the catalyst solution and drawn on 10×10 cm glass plates with 90 μm wet film thickness. Curing was performed in a drying oven at 100° C. for 1 h. Subsequently, the mounted coatings were acclimatized in the room for 1 h and the pendulum damping was determined afterwards.

In this example, the pendulum damping of different materials, including material from Example 5 with compound C-5, is compared.

| | | Pendulum |
|---|---|---|
| | | damping |
| Proportion of trimellitic | Mixing ratio of component | according to |
| anhydride in the synthesis | (C) with component (D) | König in [s] |
| 35% | 30:70 | 36 |
| | 50:50 | 22 |
| | 70:30 | 22 |
| 30% | 30:70 | 39 |
| | 50:50 | 29 |
| | 70:30 | 17 |
| 25% | 30:70 | 38 |
| | 50:50 | 53 |
| | 70:30 | 21 |
| 20% | 30:70 | 36 |
| (Material from Example 5) | 50:50 | 57 |
| | 70:30 | 36 |

1. A process for coating a granular material comprising the steps of
(a) providing a granular material;
(b) providing a compound (C) which has at least one ester bond and which is obtainable by reacting a hydroxyl group or epoxy group of a compound (A) with a carboxyl group or anhydride group of a compound (B);
(c) providing a compound (D) having at least one epoxy group;
(d) reacting compound (C) with the epoxy group of compound (D) to produce compound (E) having an ester bond;
wherein the reaction of compound (C) with compound (D) takes place in the presence of the granular material and optionally a curing agent to provide a coated granular material; and
wherein
the compound (A) has at least one hydroxyl group or epoxy group and is selected from fatty acid ester and fatty acid; and
the compound (B) is selected from:
compound (B-1) having at least two carboxyl groups; and
compound (B-2) having at least one cyclic anhydride group.

2. The process according to claim 1, wherein the compound (A) is a fatty acid ester of a polyhydric alcohol and a fatty acid.

3. The process according to claim 2, wherein the compound (A) is a triglyceride.

4. The process according to claim 1, wherein the compound (B) is a compound (B-1) having the general formula 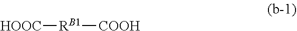
wherein R^{B1} is selected from a divalent, saturated, branched or unbranched, C₂₋₁₆ aliphatic or C₄-16 cycloaliphatic group, a C₆₋₁₆ aromatic hydrocarbon group optionally substituted with about 1 or about 2 C₁-4 alkyl groups, and an unsaturated, straight or branched, C₂₋₁₆ aliphatic or C₄₋₁₆ cycloaliphatic group, and
wherein R^{B1} may optionally be substituted with from about 1 to about 6 additional COOH groups and/or from about 1 to about 6 OH groups.

5. The process according to claim 4, wherein the compound (B-1) is selected from maleic acid, fumaric acid, succinic acid, terephthalic acid, isophthalic acid, adipic acid, glutaric acid, azelaic acid, o-phthalic acid, trimellitic acid, tricarballylic acid, trimesic acid, hemimellitic acid, pyromellitic acid, mellitic acid, malic acid, tartaric acid, mesotartic acid, racemic acid and citric acid.

6. The process according to claim 1, wherein the compound (B-2) is selected from succinic anhydride, maleic anhydride, phthalic anhydride, trimellitic anhydride, methyltetrahydrophtalic anhydride, methylhexahydrophtalic anhydride, tetrahydrophthalic anhydride and hexahydrophthalic anhydride.

7. The process according to claim 1, wherein the compound (D) is selected from fatty acid esters of a monohydric or polyhydric alcohol and an epoxidized fatty acid, epoxidized fatty acid amides, esters of an epoxidized fatty alcohol, and ethers of an epoxidized fatty alcohol.

8. The process according to claim 7, wherein the compound (D) is a fatty acid ester of a monohydric or polyhydric alcohol and an epoxidized fatty acid.

9. The process according to claim 1, wherein compound (A) is castor oil and compound (B) is trimellitic anhydride.

10. The process according to claim 1, wherein the granular material is selected from agrochemicals and desiccants.

11. A coated granular material obtainable according to the any 1 to 10 claim 1.

12. A kit comprising
(i) a compound (C) which has at least one ester bond and which is obtainable by reacting a hydroxyl group or epoxy group of a compound (A) with a carboxyl group or anhydride group of a compound (B);
(ii) a compound (D) having at least one epoxy group; and
(iii) optionally a hardener;
wherein
the compound (A) has at least one hydroxyl group or epoxy group, and is selected from fatty acid ester and fatty acid; and
the compound (B) is selected from:
compound (B-1) having at least two carboxyl groups; and
compound (B-2) having at least one cyclic anhydride group.

13. The process according to claim 10, wherein the granular material is an agrochemical selected from fertilizers, pesticides, insecticides, fungicides and soil improvers.
